(19) United States
(12) Patent Application Publication
(10) Pub. No.: US 2003/0128427 A1
(43) Pub. Date: Jul. 10, 2003

(54) Dual projector lamps

(76) Inventors: Michael H. Kalmanash, Los Altos, CA (US); Vijay M. Sethna, Fremont, CA (US)

Correspondence Address: Marvin H. Kleinberg, Esq., Suite 1080, Los Angeles, CA, 90067, US

(21) Appl. No.: 10/175,728

(22) Filed: Jun. 20, 2002

Related U.S. Application Data
(60) Provisional application No. 60/348,023, filed on Jan. 10, 2002.

(51) Int. Cl. F21V 9/14

(52) U.S. Cl. 359/484; 359/494; 362/19

(57) ABSTRACT

A dual lamp light source utilizes a polarizing beam splitter to provide an output beam from one or the other or both sources. One lamp is positioned adjacent a face whose plane is parallel to the optical axis of the beam splitter and whose output is internally reflected. The other lamp is positioned adjacent a rear face of the beam splitter so that its output is the output of the beam splitter.

Each of the beams is polarized in a unique orientation. A polarizer is placed in the exit path and is aligned to pass one of the orientations. A polarization rotation device is interposed between the beam splitter and polarizer and, by its orientation, determines which of the lamp inputs is transmitted by the polarizer. The rotation device can be mechanical, including a rotatable half wave plate or electronic, utilizing a liquid crystal retarder device that is controlled by an applied electrical signal.

The present device can also be used as a “day-night” illumination source if one lamp is a bright day lamp and the other is a less bright night lamp equipped with an IR filter. The lamps are then used alternatively.

This is a continuation-in-part of our pending Provisional Application Serial No. 60/348,023, filed Jan. 10, 2002, from which application priority is claimed.

### BACKGROUND OF THE INVENTION

1. Field of the Invention

The present invention is in the field of information display systems, and more particularly, in the field of projection displays.

2. Description of the Related Art

Liquid crystal projectors are widely used as information display devices because of their compactness, light weight, high resolution and brightness. The light source for most of these projectors is an arc lamp, which may be either metal halide, high pressure mercury vapor or xenon. Desired arc lamp characteristics are compact size, high efficiency, high (lumen) light output, broad (full-color) spectral gamut and short arc gap for efficient light utilization. Such lamps are available from a number of commercial sources, including N. V. Philips Gloeilampenfabriken, Osram, Ushio and Welch-Allyn, among others.

Less desirable characteristics of arc lamps are the lack of all but a nominal dimming capability and life expectancy of only a few hundred hours to a few thousand hours. Arc lamp failure modes are often catastrophic (i.e. zero light output), so that when a lamp fails the entire projector becomes unusable until the lamp is replaced.

There are instances where these limitations are very significant shortcomings. In outdoor applications, for example, projector light output might need to be adjusted over a very wide range to accommodate viewing ambient illumination levels, ranging from full sunlight to moonless night. The need for wide dimming is particularly important in military and defense applications, such as aircraft cockpits. Projector failure is always unwanted, but in critical applications such as in aircraft, or in other situations where access to the lamp for replacement might be difficult or especially time consuming, improved operating lifetime is a necessity.

In the prior art, dealing primarily with film projection systems in which the images to be projected were on a slide or other permanent photographic record, space and weight were not substantial considerations and therefore, projectors were provided with extra light sources which could be physically moved into the location of the primary light source.

In some instances, the second lamp was physically exchanged with the failed primary lamp as in the patents to P. M. Field et al, U.S. Pat. No. 3,294,966; Li Donnici, U.S. Pat. Nos. 3,914,645 and 4,518,233; Gehly et al., U.S. Pat. No. 5,032,962; Dreyer, Jr. et al, U.S. Pat. No. 5,135,301; and Rodriguez, Jr. et al, U.S. Pat. No. 5,241,333. A similar approach was used with an LCD projector in the patent to Park et al, U.S. Pat. No. 5,296,883, in which a plurality of arc tubes are mounted on a rotatable plate and each can be automatically brought into position as the primary light source when the arc tube in use experiences a failure.

An alternative approach to the replacing of a failed lamp is disclosed in the patent to Krasin, U.S. Pat. No. 4,061,911. Here a primary lamp and a spare are fixedly mounted in the projector. The primary lamp is on the optical axis while the replacement lamp is off axis. A movable mirror is deployed to direct the light from the replacement lamp to the optical axis when the primary lamp fails.

In overhead projectors, limited lamp life is sometimes compensated by using dual lamps which are mounted in movable cassettes, so that upon the failure of one lamp, a second is physically moved into its place. This approach is not desirable since such cassettes are bulky and susceptible to jamming, and require operator interaction to effect a lamp change. Additionally it is difficult if not impossible to precisely align the replacement lamp with such a scheme. Misalignment between the arc lamp and the condenser optics results in poorer uniformity and reduced efficiency.

Similarly, the conventional way to dim arc lamp projectors is via the mechanical insertion or adjustment of neutral density filters or mechanical irises. These approaches are bulky and relatively unreliable.

### SUMMARY OF THE INVENTION

The current invention provides an all-electronic means of selection between two lamps for a projection system, and also provides a wide dimming range for arc lamp projectors. It offers the potential for automatic lamp substitution in the event of a lamp failure.

According to the present invention, a pair of lamps are arranged along the side and the rear of a polarizing beam splitter. The p-polarized component (“P”) of the first lamp output is transmitted through the beam splitter while the second (“S”) component is reflected. The s-polarized component of the second lamp output is reflected by the beam splitter while the (“P”) component is transmitted. The output path of the beam splitter thus comprises the “P” component of the first lamp and the “S” component of the second lamp.

A liquid crystal polarization rotator is interposed in the output path of the beam splitter and at 0° passes the “P” polarized output beam through an output polarizer which is transparent for “P” polarized light. To dim the p-polarized light, the rotator is oriented toward a 90° rotation, progressively attenuating the light passing through until, at 90°, the “P” polarized light is blocked. In the case where the first lamp is off (or failed), the “S” polarized second lamp light component is reflected in the beam splitter and is now the light in the output path while the “P” component is transmitted in a direction orthogonal to the light path. However, the rotator at 0° will block the “S” polarized light. Rotating the polarization to 90° will pass the “S” polarized light and an intermediate setting will dim the light. Accordingly, dimming takes place as the rotator goes from 90° to 0°.

In one embodiment, the rotator can be a one half wave plate which is mechanically rotated through 90°. In an alternative embodiment, an untwisted nematic LCD with its director axis at 45° to the “S” and “P” polarization states could be a half-wave retarder (90° rotation) when a first voltage is applied, and a zero-wave retarder (0° rotation) when a second voltage is applied.

In another alternative embodiment, a twisted nematic (TN) LCD can serve the same function. When constructed with a 90° twist and its director axis aligned with the polarized light output of the beam splitter, full voltage would provide a 0° rotation while a 90° rotation would result from the unpowered state.

In other embodiments, if the 2nd lamp were to be a backup lamp to replace the 1st lamp in the event of failure, switching between lamps could automatically switch the lamp ballast from the 1st lamp to the 2nd lamp. A system could be devised whereby the failure of the 1st lamp could automatically switch the ballast to the second lamp and cause the rotator to an alignment that was the inverse of its original setting.

In yet another variation, the 1st lamp might be a high intensity day use lamp while the 2nd lamp might be a low intensity lamp, intended for night use. For military uses, the 2nd lamp could be filtered for NVIS compatibility. In this case, the lamps could be powered individually or could be powered simultaneously, with the polarization rotator selecting which lamp would be the illumination source.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a diagram of a preferred embodiment of a dual lamp system according to the present invention;

FIG. 2 shows an electronic polarization rotator according to an alternative embodiment of the present invention;

FIG. 3 shows an alternative electronic polarization rotator using a twisted nematic LCD;

FIG. 4 is a diagram of a system in which lamp failure is automatically sensed; and

FIG. 5 is a diagram of an alternative system in which the first lamp is a day lamp and the second lamp is a night lamp.

### DESCRIPTION OF THE PREFERRED EMBODIMENTS

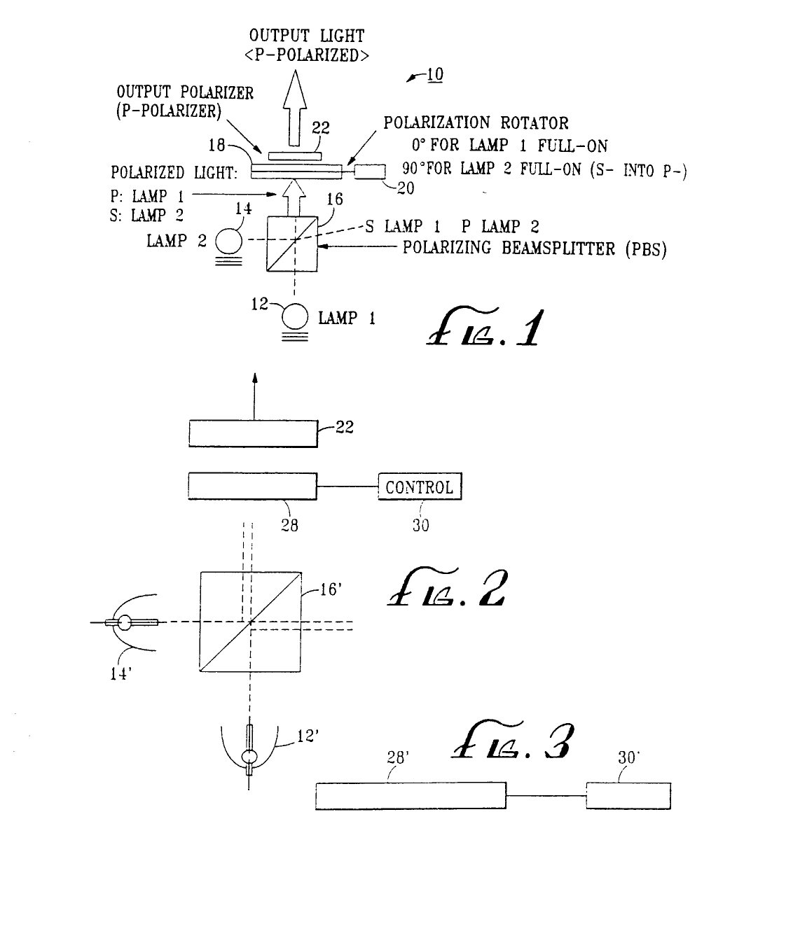

Turning first to FIG. 1, there is shown a dual lamp system 10 according to a preferred embodiment of the present invention. Two lamps 12, 14, are placed on adjacent sides of a polarizing beam splitter (PBS) 16. The PBS 16 transmits the p-polarized component of incident light and reflects the s-polarized component from the first lamp 12. If the first lamp 12 is on, a polarization rotator 18 is set by a mechanical driver device 20 to 0° rotation and the p-component of the first lamp 12 emission is transmitted through an output p-polarizer 22 and onward to the rest of the projection system.

The polarization rotator 18 can also be used to dim the light output from the first lamp 12, considering that the light exiting the PBS 16 from that lamp is p-polarized. If the polarization rotator 18 is set to 0° rotation, then this p-polarized light passes with high efficiency through the output polarizer 22.

As drive device 20 rotates the polarization rotator 18, its output is gradually transformed into light with an increasing ratio of s- to p-polarization, of which only the latter is transmitted through the output polarizer 22. The s-polarized light is absorbed in the output polarizer 22.

Thus, at 90° rotation, essentially none of the light from the first lamp 12 is transmitted through the output polarizer 22. Hence the polarization rotator 18 serves as a dimmer for first lamp 12 emission.

Consider now the case where the first lamp 12 is turned off or has failed and second lamp 14 is turned on. Here the s-component of second lamp 14 emission is reflected from the PBS 16 (toward the projection system). For this light to be transmitted through the output polarizer 22, it must be converted to p-polarization. This is done by driving the polarization rotator 18 to 90° rotation, which then becomes the condition for maximum transmittance of second lamp 14 emission. In an inverse manner than for first lamp 12, the polarization rotator can be used to dim the second lamp 14 emission by adjusting its rotation toward 0°.

The polarization rotator 18 can be mechanized in many different ways. In the simplest embodiment, it is simply a half wave plate which is mechanically rotated by drive means 20. It is known that a half-wave plate has the property of rotating polarized light symmetrically around its slow axis. Thus, for example, setting the axis of the half-wave plate to 45° with respect to the polarized light output of the PBS 16 would result in a net rotation of light by 90°.

As shown in FIG. 2, a polarization rotator has no moving parts This might be preferred in many applications and can be mechanized with liquid crystal devices (LCDs). For example, an untwisted nematic LCD 28 with its director axis set at 45° to the polarized light from the PBS 16′ can be designed to be a half-wave retarder in the unpowered state, thereby acting as a 90° rotator in this state. As the RMS voltage applied by control circuits 30 to the LCD 28 is increased, the retardation is gradually reduced toward zero, so that in its fully-on state the LCD 28 is essentially a 0° rotator.

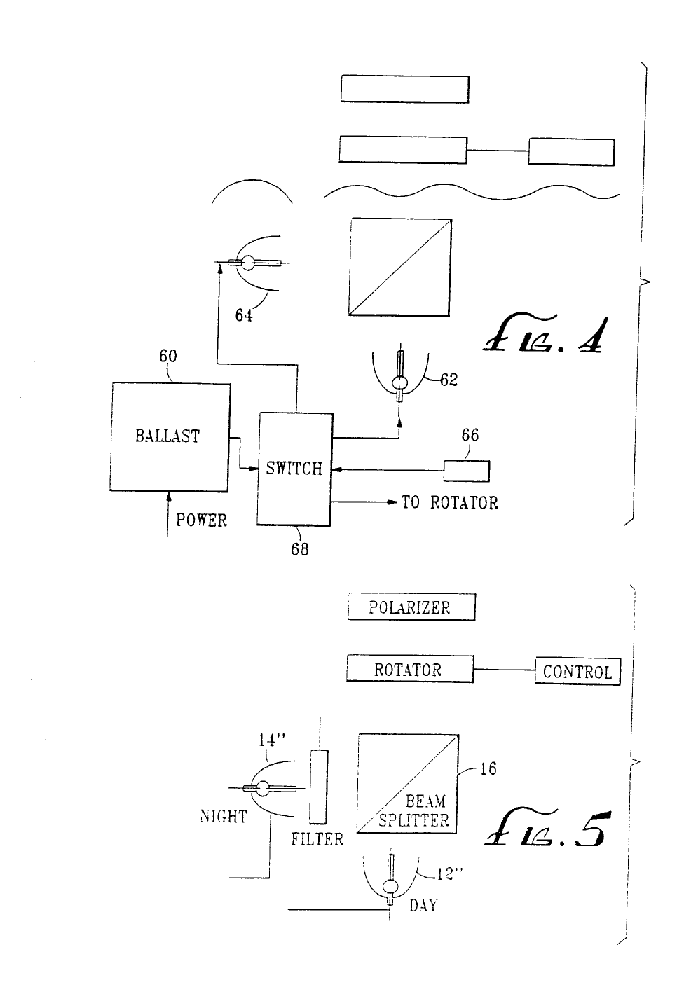

Similarly, and as shown in FIG. 3, a twisted nematic (TN) LCD 28′ can serve the same function. A TN LCD 28′ acts via optical waveguiding to control the polarization of light transmitted through it as a function of applied RMS voltage. In this application, the TN LCD 28′ would be constructed with a 90° twist and its director axis (at either substrate) would be aligned to be in line with the polarized light out of the PBS 16′. Full voltage would correspond to 0° polarization rotation. Zero voltage would correspond to 90° polarization rotation.

If a system were designed for redundancy (backup lamp in the event of failure) as shown in FIG. 4, then one need only supply a single ballast 60 for both the first lamp 62 and second lamp 64. Switching between lamps 62, 64 could be automatic in the event of lamp failure.

For example, a sensor 66 could monitor the illumination from the first lamp 62. The sensor output signal could be applied to a switch circuit 68 which normally couples ballast 60 output to the first lamp 62. When the signal from the sensor 66 falls below a predetermined level, the switch 68 applies the output of the ballast 60 to the second lamp 64. At the same time, a signal can be sent to the rotator to change to the setting which passes the second lamp 64 illumination.

In an alternative mechanization, the ballast would be nominally connected to the first lamp, for example, and the output current in the ballast would be sensed. If the current dropped to zero (indicating a lamp failure), then the ballast would be automatically disconnected from the first lamp and instead connected to the second lamp (via relays or similar means), and simultaneously the polarization rotator would be automatically set to the inverse rotation from its previous setting, to ensure the net light output remains unchanged.

There are other possible uses for this architecture, where the first and second lamps need not be identical. One such configuration is shown in FIG. 5, in which the first lamp 12″ is a high intensity lamp for high ambient daytime viewing (high luminance) and the second lamp 14″ is a low intensity lamp for night viewing (low luminance).

Since the power dissipation of first lamp 12″ would be much lower than for second lamp 14″, this would be a more efficient system than one which merely attenuated the high intensity lamp output for low luminance. Additionally, for military applications the emission from second lamp 14″ (night lamp) could be filtered for NVIS compatibility, if desired, without affecting the broad color gamut of first lamp 12″ in daytime use.

In such applications, the lamps could be powered individually, depending on which one is needed, or they could be powered simultaneously, relying on the selectivity of the polarization rotator and the output polarizer to choose the correct lamp emission. Moreover, for optimum power utilization, the lamps would be used alternatively so that the unneeded night second lamp 14″ would not be powered while the day first lamp 12″ was being operated, and vice versa.

Thus there has been shown a novel utilization of a polarizing beam splitter to selectively enable one of a pair of possible light sources. In one embodiment, the sources are substantially identical and one can be instantly employed if the other ceases to operate. In other embodiments, each source can have different characteristics and the output beam can go from light of one source through light from both sources to light from the other source by adjusting a polarization rotator.

In yet another embodiment, one of the sources may be considered a “day” source and be substantially brighter than the other source which would be considered a “night” source. If NVIS compatibility is desired, appropriate infra red filters could be inserted between the night source and the beam splitter input face.

It should be noted that although the invention has been described as particularly applicable to arc lamps, it is equally applicable to all light sources, including incandescent and fluorescent lamps.

Accordingly, the scope of the invention should only be limited by claims appended below.

1. A dual lamp source for an optical system comprising, in combination:
a polarizing beam splitter having at least first and second input faces and an output face, one of said input faces and said output face being orthogonal to an optical axis, the other of said faces being in a plane parallel to said optical axis;
a first lamp adjacent said one of said input faces for directing illumination along said optical axis, emerging from said output face polarized with a first orientation;
a second lamp adjacent the other of said input faces for directing illumination along said optical axis, emerging from said output face polarized with a second orientation different from said first orientation;
an output polarizer adapted to receive the beams exiting from said output face; and
polarization rotator means interposed between said output face and said output polarizer for changing the orientation of the polarized beam exiting from said output face,
whereby said rotator means, in one configuration, passes polarized beams of said first orientation and blocks polarized beams of said second orientation and in a second configuration, passes polarized beams of said second orientation and blocks polarized beams of said first orientation, the configuration of said rotator means selecting one of said illumination sources to supply illumination to an optical device.

2. The apparatus of claim 1, above, wherein said polarization rotator means include:
half wave plate means for changing the orientation of a polarized beam and
rotational drive means coupled to said plate means for changing the rotational orientation of said plate means whereby operation of said drive means rotates said plate means to rotate the orientation of an applied polarized beam.

3. The apparatus of claim 2, above wherein said half wave plate means have a slow axis and said slow axis is aligned to be at 45° with respect to the first orientation of polarized light.

4. The apparatus of claim 1, above, wherein said polarization rotation means include a liquid crystal device responsive to an applied electrical signal to vary optical retardation from 0° at maximum applied signal to 90° at minimum applied signal.

5. The apparatus of claim 4, above, wherein said liquid crystal device is an untwisted nematic device with its director axis set at 45° to the incoming polarized light.

6. The apparatus of claim 1, above, wherein said polarization rotation means include a liquid crystal device responsive to an applied electrical signal to vary optical retardation from 0° at minimum applied signal to 90° at maximum applied signal.

7. The apparatus of claim 6, above, wherein said liquid crystal device is a twisted nematic device with its director axis set in line with the incoming polarized light.

8. The apparatus of claim 1, above, further including ballast means alternatively connected to said first and second lamps whereby only one of said lamps is operated at any time and wherein said ballast(means can be switched from an inoperable lamp to an operable lamp.

9. The apparatus of claim 1, above, wherein one of said lamps is brighter than the other of said lamps.

10. The apparatus of claim 9, above, further including IR filtering means interposed between the less bright lamp and its input face whereby operation with only said less bright lamp provides an NVIS compatible source for night operation.
